(19) United States
(12) Patent Application Publication
(10) Pub. No.: US 2009/0124160 A1
(43) Pub. Date: May 14, 2009

(54) Printable Nanocomposite Code Cathode Slurry and its Application

(76) Inventor: Ningsheng Xu, Guangdong Province (CN)

Correspondence Address: MICHAEL N. LAU;LAU & ASSOCIATES, LLC, 2121 EISENHOWER AVENUE, SUITE 200, ALEXANDRIA, VA, 22314, US

(21) Appl. No.: 11/883,429

(22) PCT Filed: Mar. 25, 2005
(86) PCT No.: PCT/CN2005/000379

§ 371 Date: Jul. 31, 2007

(30) Foreign Application Priority Data
Feb. 7, 2005 (CN) 200510033162.6

(51) Int. Cl. H01J 9/02; H01B 1/02

(52) U.S. Cl. 445/51; 252/521.3

(57) ABSTRACT

The present invention disclose a printable nanocomposite cold cathode slurry, and a method of producing a field emission type cold cathode using the same. The slurry use electroconductive nanocomposite materials, inorganic binders, organic solvents and adjuvants as its main components. The weight ratio of the electroconductive nanocomposite materials and the inorganic binders is 0.1:1˜10:1. The organic solvents and the adjuvants in the slurry are removed by heat treatment. In the cold cathode produced with the slurry, the electroconductive nanocomposite materials and the inorganic binders form a compactly cumulated composite emission structure with a thickness of several microns to hundreds microns. In order to further increase the emission characteristics, using a selective etching technology aim at the inorganic binders to remove the solidified binders on the surface, and exposure the electroconductive nanocomposite materials beneath them. So, the field emission characteristics of the cold cathode are increased. The cold cathode slurry can be used to produce film-type or array-type cold cathode, be used as a electric source in field emission type display device, cold cathode light source and other places needing cold cathode.

### FIELD OF THE INVENTION

The invention is about printable nanocomposite cold cathode slurry and a method of preparing a field emission cold cathode using the same. The cold cathode can be used as electron source in field emission display, light source and other applications.

### TRADITIONAL TECHNOLOGIES OF THE AREA

The fabrication of cold cathode electron sources using screen printing technology is characterized by its low cost and feasibility of large area preparation. The cold cathode electron source has applications in vacuum microelectronic devices such as field emission display. Traditional printable cold cathode slurry mainly contains mixture of carbon nanotube and conductive slurry (e.g. conductive Ag slurry), or mixture of carbon nanotube, conductive silver powder, solid binding materials and organic solvents (N. S. Lee, et. al., Diamond Relat. Mater., 2001, 10:265-270). The field emission cold cathode prepared by carbon nanotube-conductive Ag slurry, after removing the organic solvents in it by heat treatment, is mainly composed of carbon nanotube, conductive metal particles and solid binding materials with the carbon nanotube on the surface as the main field emission electron source.

Since the above-mentioned slurries are not specially developed for the specific requirements of field emission display devices, they can not meet all the requirements for fabricating field emission display with good performance. First, beside carbon nanotube, some conductive micro-particles can cause field electron emission, and thus two different types of electron emission materials co-exist and work together, which affects the stability of the electron emission. Secondly, after heat treatment, there are few carbon nanotube emitters exposed on the surface of the cold cathode due to the binding materials and other impurities covering it. The few emitters give rise to low emitting current. Hence, certain surface treatments are needed to improve the field electron emission performance. For example, the impurities and large particles on the surface can be first removed using a friction polishing technology, which can expose more carbon nanotube as electron emission sources (J. M. Kim, et. al., Diamond Relat. Mater., 2000, 9:1184-1189). Then, the exposed carbon nanotube at the surface can be cleaned using plasma bombardment technologies or others. Since different impurities may exist on the surface of the cold cathode after heat treatment, it is very difficult to get rid of all impurities using surface treatment.

The invention publishes a different printable cold cathode slurry and a method of producing a cold cathode using the slurry. The prepared cold cathode has a different structure compared with the above-mentioned types of printable cold cathode. The new cold cathode has excellent field emission properties and is suitable for the fabrication of vacuum microelectronic devices such as field emission display.

### PURPOSE OF THE INVENTION

The invention is about a printable nanocomposite cold cathode slurry and a method of producing a field emission cold cathode using the same, which is designed for the specific requirements for the fabrication and application of vacuum microelectronic devices. The invention also publishes a certain technology of improving field emission via surface treatment, which can be directly used to fabricate field emission display device using screen printing thick film technologies.

### EMBODIMENTS OF THE INVENTION

The printable cold cathode slurry in the invention is mainly composed of conductive nanomaterials, inorganic binders, organic solvents and assisting vehicles. The conductive nanomaterials can be one or any combinations of carbon nanotubes, carbon nanorods, fullerene (C60), carbon nano-particles, metal and semiconducting nanowires, nanorods or nanobelts.

The printable cold cathode slurry in the invention uses an inorganic insulating binder, typically nano-silicon-dioxide. The nano-silicon-dioxide can be filled into the slurry in the form of silicon sol or others. Beside this, other inorganic insulating nanomaterials such as oxide and other compounds can also be used. The weight ratio of conductive nanomaterials and inorganic insulating binders is 0.1:1˜10:1. If the value is below 0.1:1, cracks and peeling-off caused by stress will happen, and if it is over 10:1, the emission of the cold cathode will be influenced.

To satisfy the requirements of the screen printing process, the slurry can be added with various organic solvents and adjuvant vehicles, including viscosifier, dispersant, plasiticizer and surface active agent, which can adjust the viscosity and fluidity of the slurry. There are not special limit to organic solvents and adjuvant vehicles. Beside commonly-used ethanol, glycol, isopropanol, hydrocarbon, water and their mixed solvents, other common additives, like viscosifier, dispersant, plasticizer and surface active agent, can be used. The amount of the organic solvents and adjuvant vehicles depends on the specific printing technology.

After mixing the above components well, the slurry can be prepared on the substrate with screen printing or ultraviolet (UV) curing methods. The substrate can use conductive materials, like metal, alloy or doped silicon wafer, or insulating materials. When using insulating materials, like ceramic and glass, a conductive layer should be prepared on it, which makes the substrate conductive, for example, by coating conductive films of metal or indium-tin-oxide (ITO) with vacuum deposition technologies. After the cold cathode slurry is prepared on the substrate, the organic solvents and adjuvant vehicles can be removed from the slurry after heat treatment over 300. Then, the field emission cold cathode was formed with the compact combination of inorganic binder and conductive nanomaterials. Meanwhile, good adhesion between the cold cathode and the substrate was formed.

To further optimize the field emission characteristics, a selective etching (e.g. plasma etching or wet etching) is used to remove the binders on the surface and to exposure the conductive nanomaterials beneath them. After the etching, the field emission characteristics of the cold cathode can be improved. Different from the methods used in the invention, the surface of other cold cathodes are cleaned unselectively using physical sputtering. The selective etching in the invention is to aim at only removing the binding materials on the surface of the electron sources, and exposing conductive nanomaterials beneath them to form new emitters.

In addition to the screen printing method, photo sensitizers can be added into the slurry to form photosensitive cold cathode slurry. By using spinning-coating or brush-coating, the cold cathodes can be coated uniformly on the substrate, and then patterned cold cathodes can be prepared on the substrate using of UV exposure and curing. The cold cathodes prepared by UV curing have finer shapes for further use in the field emission display device with a high resolution.

The cold cathode slurry in the invention can be used to fabricate cold cathode film or cold cathode arrays, which are suitable to use as electron sources in field emission display device, cold cathode light source and other applications which need cold cathodes.

### FIGURE CAPTIONS

The following figures and their detailed explanations give further instructions of the embodiments and advantages of the invention.

FIG. 1 is the schematic structure of the cold cathode prepared on the conductive substrate.

FIG. 2 is the schematic structure of the cold cathode prepared on the insulating substrate.

FIG. 3 is the schematic structure of the cold cathode prepared on the conductive substrate after a selective etching.

FIG. 4 is an electron source prepared by the cold cathode slurry in the invention and its application in a pixel tube.

FIG. 5 is the schematic structure of a planar lighting source with the cold cathode in the invention.

FIG. 6 is the schematic structure of diode field emission display with the cold cathode in the invention. (a) strip-shaped cathode; (b) point-shaped cathode.

FIG. 7 is the schematic structure of a gated field emission display prepared by the cold cathode in the invention.

FIG. 8 is scanning electron microscopy (SEM) images of the surface of the cold cathode prepared with the cold cathode slurry in the invention and the distribution of field emission sites observed from the cathode. (a) and (b) are the SEM image and the field emission site distribution before surface treatment, respectively; (c) and (d) are is the SEM image and the field emission site distribution after surface treatment, respectively.

FIG. 9 is the transmission electron microscopy (TEM) picture of the cold cathode prepared with the cold cathode slurry in the invention.

FIG. 10 is the field emission current density versus applied field (J-E) characteristics of the cold cathode prepared with the cold cathode slurry in the invention. (a) Before surface treatment, (b) after surface treatment.

FIG. 11 is the stability of the field electron emission current of the cold cathode prepared with the cold cathode slurry in the invention. (a) Before surface treatment, (b) after surface treatment.

FIG. 12 is a picture of the field emission display device prepared with the cold cathode in the invention.

FIG. 13 is the picture of the field emission display shown in FIG. 12 when operating at line scanning.

### EXAMPLES

The following further explains in details about the cold cathode slurry and the method of producing the cold cathode using the same as well as its applications.

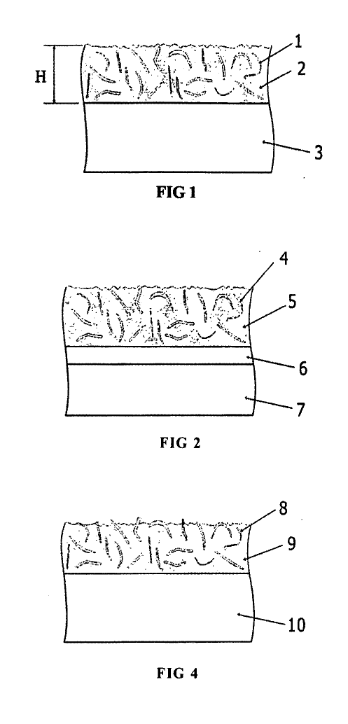

FIG. 1 shows the schematic structure of the cold cathode prepared on the metal substrate (3). In the cold cathodes shown in FIG. 1, the conductive nanomaterials (1) and the inorganic binders (2) form a compact composite structure with a thickness of several microns to hundreds microns (H in FIG. 1). The conductive nanomaterials are line-shaped, and may be carbon nanotube, carbon nanorod or other metallic or semiconducting nanowires, nanorods and nanobelts with their diameters of several nanometers to hundreds nanometers and the length of several tenth of a micro to hundreds microns. The shape of the conductive nanomaterials may be straight or curve, most of which are buried inside inorganic binders and some of which protrude from the surface of the inorganic binders. The inorganic binders are also in nanoscale with their diameters or lengths being several nanometers to hundreds nanometers.

When the cold cathodes are prepared on insulating substrate, such as ceramic or glass, a conductive layer shall first be prepared on it. The structure of the cold cathode at the moment is shown in FIG. 2 with (7) representing the substrate and (6) representing the conductive layer, on which the cold cathode is prepared with the cold cathode slurry in the invention. In the cold cathode, the conductive nanomaterials (4) and the inorganic binders (5) form a compactly-stacked composite structure. The conductive layer may be metal film, screen printing conductive silver layer or other conductive film (such as SnO₂ or ITO).

The selective etching technology (e.g. plasma etching or wet etching) can be used to treat the surface of the cold cathode. The etch gas or liquid only selectively remove the binders rather than conductive nanomaterials beneath them. FIG. 3 shows the schematic structure of the cold cathode after a selective etching. Compared with the cold cathode before the etching, there are more exposed conductive nanomaterials (8) after the binding materials (9) on the surface of the electron source were removed, which improves the field emission performance of the cold cathode. In FIG. 3, (10) is the conductive substrate.

Using the screen printing technologies, the cold cathode slurry can be prepared on the whole area or at a certain area of the substrate, to form cold cathode film or arrays. Metal, glass, ITO glass, ceramic or silicon wafer can be used as the substrate. Various field emission display devices can be fabricated using the cold cathode in the invention.

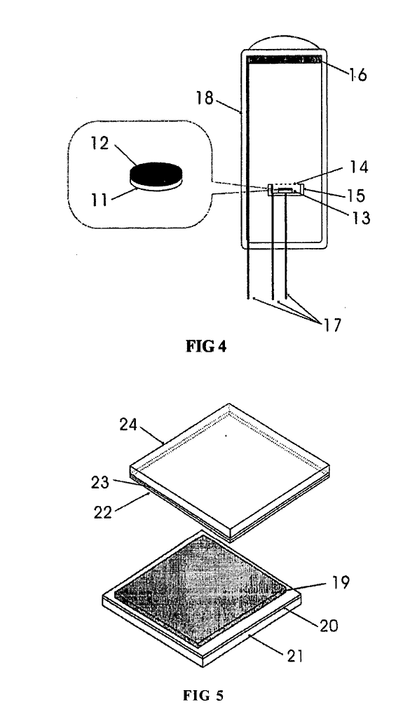

FIG. 4 is a single electron source (12) prepared on the metal substrate (11). The single electron source can find application in the cold cathode pixel tube. FIG. 4 shows the structure of a cold cathode pixel tube. Gate grid (14) is mounted on the top of the cathode (13). The grid is insulated by insulator (15). Commonly, the gate grid is made of metal grid. The whole device is encapsulated in glass (18) and high vacuum is maintained inside the device after sealed off. The electrodes for the anode, cathode and gate grid are leaded out via feedthroughs (17) on the stem. When a voltage is applied on the gate grid (14), electrons are emitted and bombard the phosphor screen (16), which produces visible light. The pixel tube can be used for large screen information display.

FIG. 5 is the schematic structure of a planar lighting source prepared with the cold cathode in the invention. The cold cathode in the invention is prepared uniformly on the whole glass substrate (21) with a conductive layer (20). A diode device is formed with the cold cathode (19) and phosphor screen (24) which is coated with a conductive layer (23) and a fluorescent layer (22). When a voltage is applied to phosphor screen (24), the emitting electrons bombard phosphor screen (24) and make it produce visible light. The device can be used for illumination or the backlight of liquid crystal display (LCD).

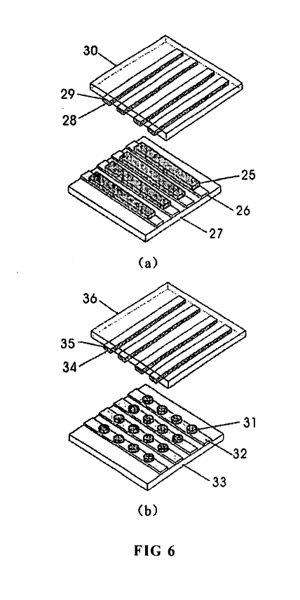

FIG. 6 is the schematic structure of diode field emission display prepared with the cold cathode in the invention. The cold cathode can be strip-shaped or point-shaped, as (a) and (b) shows respectively. In FIG. 6 (a), conductive electrode strip is first fabricated on the insulating substrate (27), e.g. glass, and then strip-shaped cold cathode (25) is prepared on the conductive cathode electrode. Glass plate (30) is used as substrate for the phosphor screen, on which strips of transparent electrode (anode, 29) and phosphor layer (28) are prepared. In FIG. 6 (b), conductive electrode strip (32) is first fabricated on the insulating substrate (33), and then point-shaped cold cathode (31) is made on the conductive cathode electrode. There is no limit to point shape. The phosphor screen also uses glass plate as the substrate (36), on which transparent electrode strip (anode, 35) and phosphor layer strip (34) are made. The cathode plate and the phosphor screen are assembled together with certain gap, both of which are insulated by insulator spacers. When the anode electrodes and cathode electrodes are applied with voltage crosswise, corresponding electron source at the crossed places emits electrons and the electrons bombard the phosphors powder, which makes corresponding points emit visible light. When the anode and cathode are applied with voltage and scanned in sequence, grayscale images can be displayed by controlling the voltage of the scanned points.

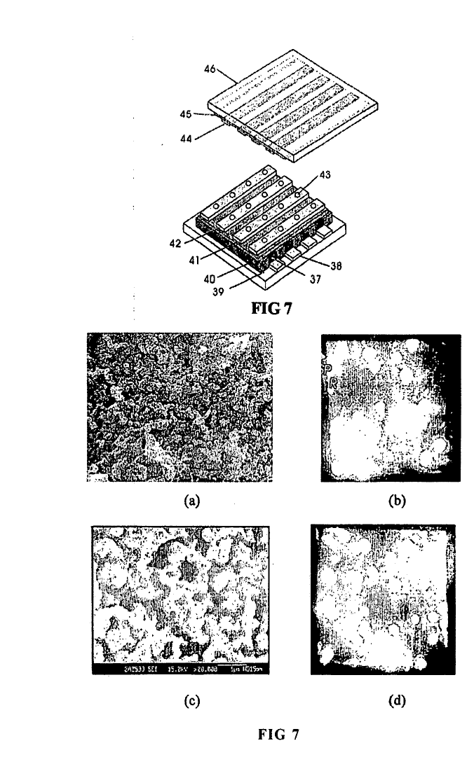

FIG. 7 shows the schematic structure of the gated field emission display prepared by the cold cathode in the invention. First, conductive electrode strips are made on the insulating substrate (39), and then strip-shaped or point-shaped cold cathode (37) is made on the conductive cathode electrodes. Then, an insulating layer (40) shall be prepared first between the cold cathode for the next preparation of an insulating layer (41) on the electron source. And then, the conductive gate electrodes (43) are prepared on the insulating layer perpendicularly with the cathode electrodes. Next, gate apertures (43) can be formed by etching the conductive gate electrode and the insulating layer, which expose the cathodes in the apertures. When voltage is applied between the gate electrode and the cathode electrode, corresponding electron source at the crossed place emits electrons and electrons bombard the phosphor screen which is applied with high voltage. Visible light is produced at corresponding points. The phosphor screen is prepared on glass substrate (46), on which transparent electrode strip (45) and phosphor layer strip (44) are prepared. The plate with the cathode and gate and the phosphor screen are assembled together, both of which are insulated by spacers and form a triode-structured field emission display. At operation, constant voltage is applied to the phosphor screen. When voltage is applied to the cathode and gate electrodes, grayscale images can be displayed by controlling the voltage of the scanned points.

To further explain the invention, detailed examples are given as follows. However, the invention is not limited to these examples. In example 1, the conductive nanomaterials are carbon nanotubes and the inorganic binder uses nano-silicon dioxide, which is added in the form of silicon sol. Example 2 is about an application of the above cold cathode in a field emission display.

### Example 1

The example is about a method of producing a cold cathode slurry and a cold cathode. And example of surface treatment is also given.

Firstly, the carbon nanotubes are purified and dispersed, and then added into nano-silicon dioxide sol and water, both of which shall be mixed well. Then, the organic solvents and adjuvant vehicles, like glycol, carboxymethyl cellulose (CMC) and sodium polyacrylate, are added into it. And ball milling is carried out. The weight ratio of the carbon nanotube, silicon sol, CMC, sodium polyacrylate glycol and water is 1:2:0.01:0.0005:0.25:2. The content of the solid in the slurry is about 20%.

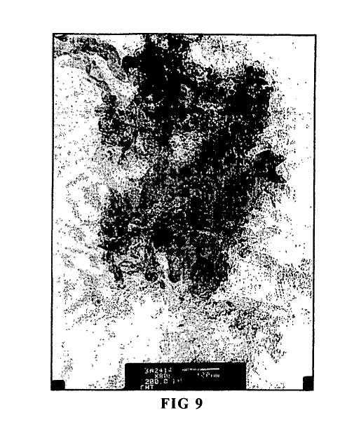

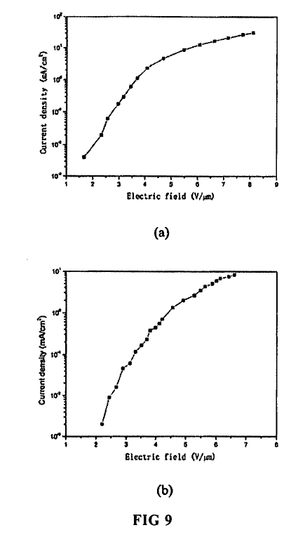

After the slurry is prepared, the cold cathode can be prepared on the conductive ITO glass substrate using screen printing method. The thickness of the cold cathode is about 100 microns. Afterheat treatment at 450 for 30 minutes, the organic components in the slurry is removed. Good mechanical adhesion and electrical contact between the cold cathode and the ITO glass substrate were formed. The surface morphology of the prepared cold cathode is shown in FIG. 8 (a). Its TEM picture is shown in FIG. 9, which indicates that compact composite structure of nanotube and inorganic nano-binders was formed.

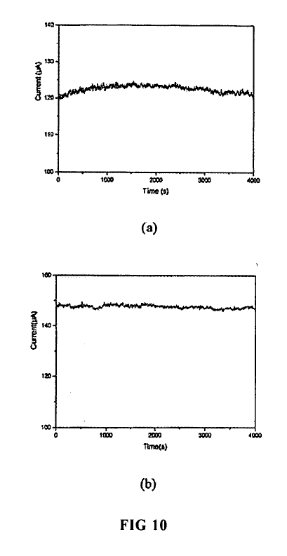

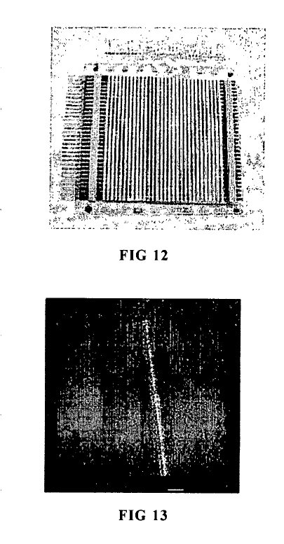

The field emission characteristics of the cold cathode was tested in high vacuum (˜4 10⁻⁵ Pa). A phosphor screen was installed in front of the cold cathode with a gap of 100 μm and voltage was applied to the phosphor screen. The field emission current and the images of emission site distribution were recorded. FIG. 10 (a) shows the typical current density-applied field (J-E) characteristics. The image of emission site distribution is shown in FIG. 10(b). One can obtain that the turn-on field is 2 V/μm with corresponding current density of 10 μA/cm² and threshold field is 5.7V/μm with corresponding current density of 10 mA/cm².

The surface of the cold cathode is treated using the plasma etching, which _{C2F6} and CHF₃ are used as reaction gas. The radio frequency power for treatment is 200 W and treatment duration is 160 minutes. The SEM image of the surface morphology after treatment is shown in FIG. 8 (c). FIG. 10 (b) shows the field emission J-E characteristics. The picture of emission site distribution is shown in FIG. 10(d). After 160 minutes of plasma etching, the turn-on field is 3˜4V/μm with corresponding current density of 10 μA/cm² and threshold field is 7˜8V/μm with corresponding current density of 10 mA/cm².

FIGS. 11 (a) and (b) shows the stability of the emission current before and after surface treatment. Before plasma etching, the emission current first rises and then descends along with the working time with a fluctuation of 4% when the emission current is 120 μA, and then tends to be constant after a long time of aging. After the surface treatment, the field electron emission current begins to be stable without the long time of aging. When the electric field is applied for the first time, the emission current quickly becomes stable and no dramatic current rise and drop were observed. With the increasing operation time, the emission current has a small fluctuation below 2%.

The above results show that plasma etching slightly increases the turn-on field and the threshold field of the cold cathode. While the stability, uniformity and consistency of cold cathode are improved. Furthermore, aging process is not required for obtaining stable electron emission.

### Example 2

The example is about a method of producing a field emission display using the cold cathode in the invention. The structure of the diode device is shown in FIG. 6 (b). The preparation of the cold cathode slurry is the same as that described in example 1.

After the slurry is prepared, the cold cathode is prepared on the conductive ITO glass substrate using the screen printing method. Chromium (Cr) electrode strips are first prepared using magnetron sputtering through a shadow mask, and the cold cathode slurry is printed on the Cr electrode to form electron sources using screen printing method. The electron sources were arranged in arrays and each has diameter of 0.5 mm and a thickness of about 100 microns. After heat treatment at 450 for 30 minutes, the organic components in the slurry were removed and good adhesion among the cathode, conductive electrodes and the glass substrate were formed.

Then, ITO conductive strips on the glass are prepared using lithography technologies, and the phosphor strips are prepared on the ITO conductive strip using screen printing method. The field emission display can thus be prepared by assembling the cathode substrate and the phosphor screen together, both of which are insulated by spacers with a gap of 100 microns. Electrical connections are lead out from both sides of the cathode substrate and the phosphor screen. The whole device is then sealed and exhausted until it reaches high vacuum of about 1 10₋₄ Pa. When voltage is applied between certain anode electrode and cathode electrode, the phosphor screen can be illuminated by emitting electrons at a point of the cold cathode. Display of characters and images were achieved by the scanning driving. FIG. 13 shows image of the field emission display when the certain line of the device is scanned.

1. A printable nanocomposite cold cathode slurry, comprising one of conductive nanomaterials, nano-inorganic insulating binders, organic solvents and water.

2. The printable nanocomposite cold cathode slurry of claim 1, wherein adjuvant vehicles in the slurry may be one or any combinations of viscosifier, dispersant, plasiticizer and surface active agent.

3. The printable nanocomposite cold cathode slurry of claim 1, wherein the conductive nanomaterials may be one or any combinations of carbon nanotube, carbon nanorod, fullerene (carbon 60), carbon nanoparticle, metal and semi-conductive nanowire, nanorod or nanobelt.

4. The printable nanocomposite cold cathode slurry of claim 1, wherein the nano-inorganic binders are inorganic insulating materials.

5. The printable nanocomposite cold cathode slurry of claim 1, wherein a weight ratio of conductive nanomaterials and inorganic binders is 0.1:1˜10:1.

6. The printable nanocomposite cold cathode slurry of claim 1, wherein the nano-inorganic binders can use nano-silicon dioxide.

7. A method of producing a field electron emission cold cathode, comprising a plurality of steps of:
a) preparing a printable nanocomposite cold cathode slurry comprising one of conductive nanomaterials, nano-inorganic insulating binders, organic solvents and water on an conductive substrate;
b) removing the organic solvents, water and adjuvant vehicles via heat treatment, make the inorganic binders and the conductive nanomaterials combine compactly, and then
c) producing a field emission cold cathode with a thickness of several microns to hundreds of microns.

8. The method of producing the field electron emission cold cathode of claim 7, wherein the production of the cold cathode slurry in step a) uses screen printing thick film technologies and UV curing technologies.

9. The method of producing the field electron emission cold cathode of claim 7, wherein the plasma etching or wet etching technologies after step b), the inorganic binders on the surface of the slurry can be removed selectively while the conductive nanomaterials beneath it can be exposed.

10. The method of producing a field electron emission cold cathode of claim 7, comprises applying electron sources in the field emission display and light source.

11. The method of producing a field electron emission cold cathode of claim 8, comprises applying electron sources in the field emission display and light source.

12. The method of producing a field electron emission cold cathode of claim 9, comprises applying electron sources in the field emission display and light source.
